(19) United States
(12) Patent Application Publication
(10) Pub. No.: US 2020/0272875 A1
(43) Pub. Date: Aug. 27, 2020

(54) System, Method And Apparatus And Computer Program Product To Use Imperceptible SONAD Sound Codes And SONAD Visual Code Technology For Distributing Multimedia Content To Mobile Devices

(71) Applicants: Lev Neymotin, Plainview, NY (US); Samuel Neymotin, Plainview, NY (US)

(72) Inventors: Lev Neymotin, Plainview, NY (US); Samuel Neymotin, Plainview, NY (US)

(21) Appl. No.: 16/790,094

(22) Filed: Feb. 13, 2020

Related U.S. Application Data
(60) Provisional application No. 62/811,227, filed on Feb. 27, 2019.

(51) Int. Cl. G06K 19/07; G06K 19/06; G10L 19/018; G06F 16/955; G06F 16/432

(52) U.S. Cl. CPC G06K 19/0728; G06K 19/06037; G06F 16/433; G06F 16/955; G10L 19/018

(57) ABSTRACT

A system, method, and apparatus, to distribute and deliver to mobile computing device any multimedia content including non-interrupting, actionable advertisements, promotions and information by using imperceptible to humans sound codes embedded in audio and, alternatively or in tandem, by using visual codes printed on paper or displayed on any electronic screen is provided. The invention enriches the format of traditional broadcasting and digital content delivery through any existing digital and print media channel by augmenting the programming and printed text with unlimited information residing on the Internet. All this added information, including text, video, graphics, and sound is made available to listeners or viewers seamlessly, in real time and contextualized with the programs—radio, TV, arena broadcasting, public address system broadcasting, and Internet, either live or pre-recorded.

### CROSS-REFERENCE TO RELATED APPLICATION

This application claims benefit to U.S. Provisional Patent Application No. 62/811,277, filed Feb. 27, 2019, now pending, the disclosures of which are incorporated by reference herein in their entirety.

### BACKGROUND OF THE INVENTION

The present invention relates to digital content delivery, and more particularly delivery of contextualized multimedia content concurrently with a primary media content flow transmitted through any media channel, including print.

Informational messages traditionally aired over radio, television, sent via Internet or public address systems, and displayed on screens or printed on paper have limited effectiveness: they do not leave a lasting impression in peoples' minds, and may be stressful for listeners trying to remember phone numbers, long email addresses or any other important information needed for response or use. Importantly, once heard or read, the information has a short life: it does not have any presence on the modern mobile devices people carry. In addition, the broadcast messages or advertisements are disruptive and irritating to consumers and diminish their enjoyment by interrupting the flow and content of programs.

In more technical terms, traditional broadcasting or content delivery is a single-stream flow of information such as an audio program played over radio, a video, movie, concert, or lecture, etc., each transmitted as a single channel information stream—video or audio, or in the case of print media—only text and images. The receptors of this information flow are the individual's ears and eyes, as personal mobile digital devices such as phones or electronic pads are not engaged. The mechanism of information delivery being used today is very similar to the mechanisms used decades ago, with some minor improvements to the quality of the video and audio materials. In other words, powerful digital technologies have not yet been implemented meaningfully in the methods of information delivery, especially in traditional broadcasting and print.

When applied to the field of advertising: The present-day advertisements delivered to the consumers over internet or Wi-Fi are as disruptive as the traditional radio and television broadcast advertising. As before, they are delivered without any contextualization with the content of the programs or synchronization with the immediate activities and interests of the consumers, and, as a result, are received by them negatively. In response to the consumers' displeasure, the marketplace developed a myriad of software gadgets blocking internet and Wi-Fi-based advertisements. The consequence is—generally unhappy consumers and advertisers receiving reduced return on their investment.

The print media, in its turn, provides only a what-you-see-is-what-you-get service both in advertising and content delivery: there is no effective connection between the printed material and the topic-related unlimited multimedia information residing on Internet. The present invention enables providing the missing connection.

As can be seen, there is a need for improved systems, apparatus, and methods to make delivery of multimedia content via traditional audio/video-based media, including print rich in content and non-disruptive to human experience.

### SUMMARY OF THE INVENTION

Aspects of the present invention provide a system, method and apparatus and computer program product that utilizes imperceptible to human sound and visual codes to deliver multimedia content to consumers via application software that resides on their computing devices. Preferably the computing device is portable and can be for example a smart watch, smart phone, tablet or other portable or mobile computing device.

In aspects of the present invention the sound and visual codes encode alphanumeric data that act as tags or identifiers for multimedia content stored on computer networks that are connected to the consumers' computing devices. This enables download of multimedia content to the consumers' computing devices which is viewable at their discretion.

### BRIEF DESCRIPTION OF THE DRAWINGS

FIG. 1 is a diagram illustrating the structure of SONAD Sound Codes composed of segments of sounds of different frequency.

FIG. 2 is a diagram illustrating design and storage of packages of multimedia information (SONA) and creation of the associated SONAD Sound Codes and SONAD Visual Codes. A SONA, or multimedia capsule is a collection of multimedia items jointly covering a subject area.

FIG. 3 is a diagram illustrating the delivery of packages of multimedia information (SONAs) to phones for its subsequent presentation on the phone screens and use.

FIG. 4 is a chart showing the application of the method for multimedia content delivery to phones as SONAs.

FIG. 5 is a chart illustrating two phone screens that display links and multimedia content on the phone after the user receives a SONA.

### DETAILED DESCRIPTION OF THE INVENTION

Broadly, embodiments of the present invention provides a system, method and apparatus and computer program product that utilizes imperceptible to humans SONAD Sound Codes and SONAD Visual Codes to deliver multimedia content to consumers via application software in connection to an input device that then remains on their computing device indefinitely. Preferably the computing device is portable and can be for example a smart watch, smart phone, tablet or other portable computing device. The description is not to be taken in a limiting sense, but is made merely for the purpose of illustrating the general principles of the invention, since the scope of the invention is best defined by the appended claims.

Informational messages traditionally aired over radio, television, Internet or public address systems, displayed on screens, or printed have limited effectiveness: they do not leave lasting impressions in peoples' minds, and may be stressful for listeners trying to remember phone numbers, long email addresses or any other important information needed for response or use. In addition, the broadcast messages or advertisements are disruptive and irritating to consumers and diminish their enjoyment of the programs they interrupt.

In more technical terms, traditional broadcasting is a single-stream flow of information such as audio produced by a talk show host or news anchor, a video, movie, concert performance, print media, or lecture, etc., each transmitted as a single-channel information stream—video, audio, or print. The physical receptors of that flow of information are the individual's ears and eyes, as personal digital devices such as smartphones or electronic pads are not engaged. This traditional mode of broadcasting or print media exists today as it did decades ago, with only minor qualitative improvements of the video/audio material. In other words, powerful digital technologies have not even scratched the surface of the traditional formats of broadcasting, arena information delivery, and print.

The present invention enables delivery of additional multimedia information and advertisements directly to consumers' mobile computing devices—concurrently and synchronized with broadcasts—without interrupting their flow.

The present invention uses imperceptible SONAD Sound Codes and SONAD Visual Codes to deliver multimedia content and advertisements to consumers that will remains on their phones indefinitely. In contrast, traditional content delivery or broadcast advertising methods are disruptive, irritate consumers, and leave very limited impressions or information.

The present invention enriches the format of traditional information and advertising delivery, including broadcasting and print media, by augmenting it with the unlimited multimedia information residing on the Internet. Using the present invention, all this information, including text, video, graphics, and sound, is made available to the listener, viewer or reader seamlessly, in real time and contextualized with any program—radio, TV, public address system, live or pre-recorded, or delivered via internet, and print material.

The present invention provides a system composed of a sound or visual code(s) (or both) which may be broadcast in conjunction with an audio or visual or audio-visual presentation. The sound or visual code may then be received by a networked computing device having input devices in the form of a microphone or camera. Once received, the sound or visual code(s) is detected by application software running on the networked computing device. The sound or visual code(s) contains instructions sufficient to cause the networked computing device application software to retrieve one or more multimedia information from a second networked device (for example a database connected to the Internet) and to display that multimedia information at a time or times determined by the user of the networked computing device. For example, a user could choose to stream the multimedia information as it is received during a program—radio, TV, public address system, live or pre-recorded, or delivered via internet, and print material. And, the user could choose to view the multimedia information after the program has ended, or during playback of the program.

As a use case, for example, a classroom lecture could broadcast sound or visual code(s) receivable by networked computing devices having the application software and being operated by users in the classroom lecture, enabling them to choose to playback or stream the received multimedia information during the lecture. In a further example the multimedia information could for example be musical compositions hosted on for example Youtube™ that a music theory lecturer provides via an amplified sound system and that cause the application software to deliver said music to the user's networked computing devices. The lecturer could then cue the users to play the multimedia information during relevant times in the lecture.

Similarly, a concert venue or musician could broadcast sound or visual code(s) receivable by networked computing devices having the application software and being operated by users attending the concert. They could then encourage the audience to playback the downloaded multimedia information during intermissions or breaks in the program (or users could decide when to play back the multimedia information). In this use case the multimedia information could be advertising for concert-related merchandise, tickets for future shows or acts, or even first-time releases of the artist's new music or music video or bonus media for concert-goers.

In this way multimedia information is presented timely with the event to the recipient without forcing them to view it or non-consensually interrupting their interaction with the event.

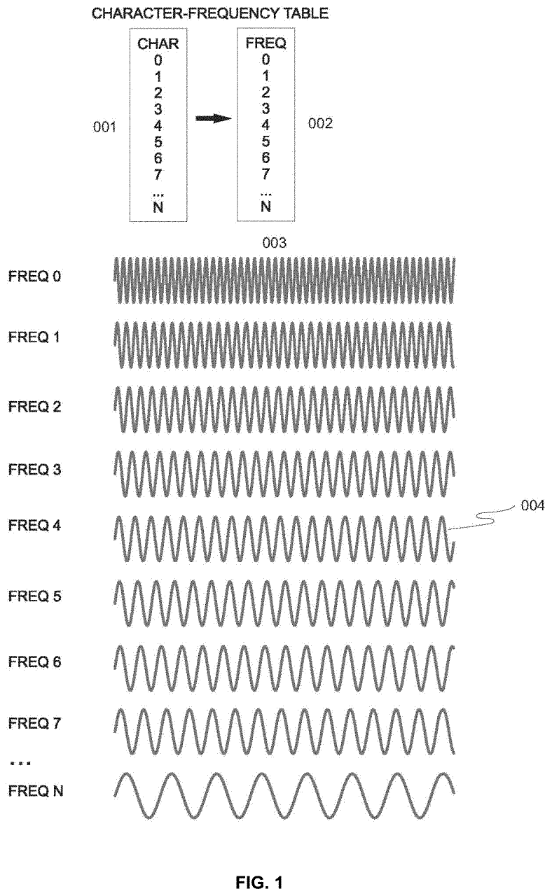

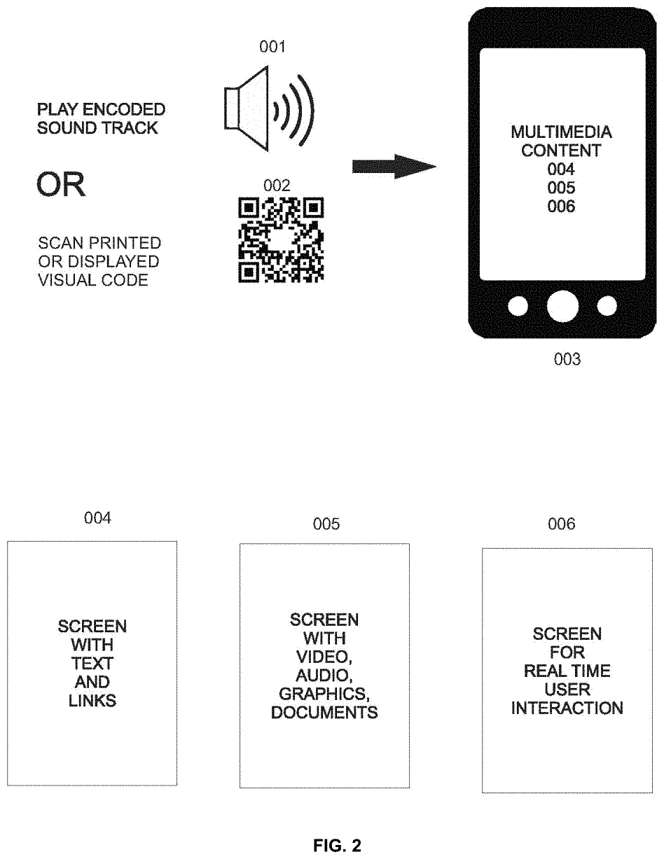

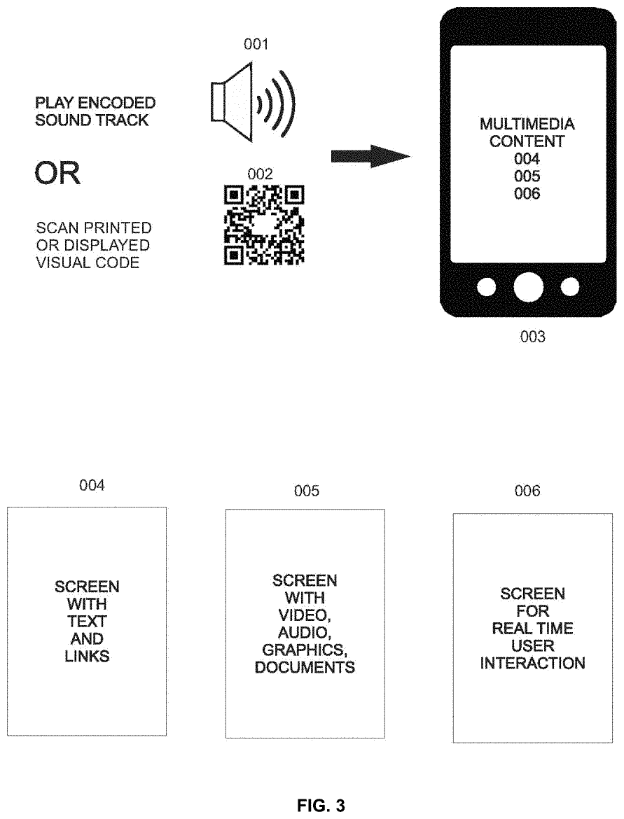

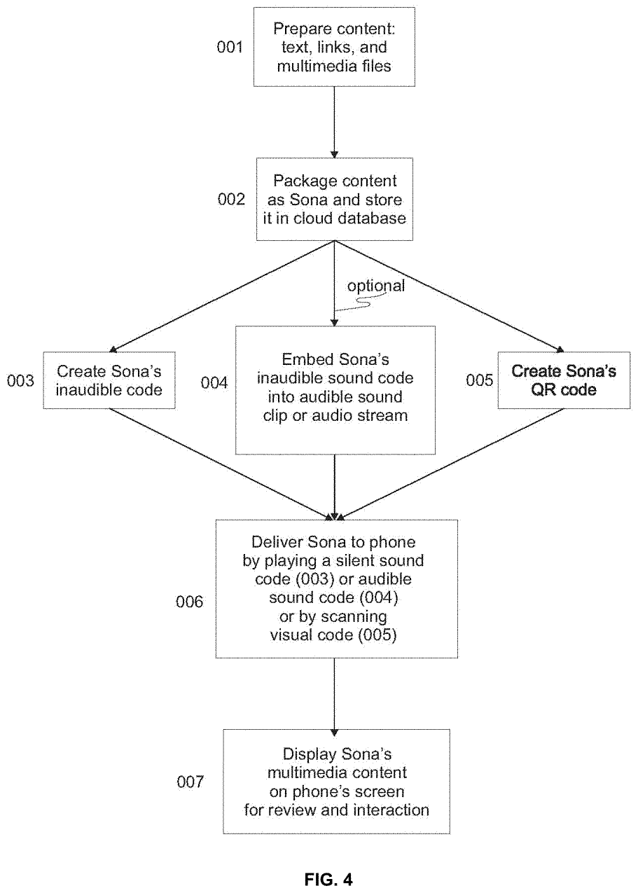

Embodiments of the present invention may include the following elements:
1. FIG. 1, 003: Character-Frequency Table
2. FIG. 1, 004: Sounds of different frequency
3. FIG. 2, 004 005: Unique codes consisting of N characters and expressed as character strings or SONAD Visual Code images
4. FIG. 2, 003 Unique codes consisting of N characters or graphical symbols expressed as SONAD Visual Code images
5. FIG. 2, 001: SONA
6. FIG. 2, 007: Inaudible SONAD Sound Code consisting of N sound segments of different frequency
7. FIG. 2, 008: Audible sound track
8. FIG. 2, FIG. 2, 009: Audible sound track with encoded inaudible SONAD Sound Code
9. FIG. 2, 002: SONA database in the cloud
10. FIG. 2, 004: Sona SONAD Visual Code
11. FIG. 3, 001: Audio speaker
12. FIG. 3, 003: Mobile app intercepting SONAD Sound Codes and scanning SONAD Visual Codes.
13. Visual Core Reader Visual Code Reader designed for reading SONAD Visual Code images FIG. 2 006 carrying unique SONA character codes, FIG. 2 005 encoded into those Visual Code images.
14. FIG. 4 method steps 001-007

A method according to aspects of the invention is disclosed using the components and elements as presented below in ten steps and positions.

An audio-barcode technology using inaudible SONAD Sound Codes embedded in audio track of radio and TV broadcasts, arena and public address systems, and into audio and video programming transmitted through Internet to deliver contextual multimedia content encapsulated in SONAs (FIG. 2 001) directly to mobile phones and tablets, as shown in reference to FIG. 3, 001.

A customized SONAD Visual Code technology allowing delivery of multimedia content to mobile phones and electronic tablets by scanning SONA SONAD Visual Codes placed on printed pages or posters, TV, PC or any other electronic screens as shown in reference to FIG. 3 002.

STEP 1. Create a unique character string consisting of N alpha-numeric characters, such as shown in reference to FIG. 2 003.

STEP 2. Assign a sound element (segment) to each character of string FIG. 2 003 with the appropriate frequency following the CHARACTER-FREQUENCY TABLE, FIG. 1 003. All frequencies in that table are in the range of the sound spectrum imperceptible by the humans. FIG. 1 004 illustrates elements used to construct the SONAD Sound Code, FIG. 2 004 as sound signals of different frequency.

STEP 3. Generate a SONAD Sound Code in FIG. 2 003, according to the CHARACTER-FREQUENCY TABLE specified by FIGS. 1 001 and 002. The specific frequency of each SONAD Sound Code element (three such elements are shown in FIG. 2 007) is equal to the frequency assigned to the specific alpha-numeric character using information from CHARACTER-FREQUENCY TABLE specified by FIGS. 1 001 and 002. The SONAD Sound Code elements corresponding to each character are arranged back-to-back in the resulting composite SONAD Sound Code audio file that consists of N sound elements, FIG. 2 007.

STEP 4. A unique SONAD Sound Code is automatically associated with each particular SONA, FIG. 2 001 that may include text, pictures, audio or video clips, links to internet or user's mobile device and telephone numbers. All SONAs are created by the content distributor through a dedicated application running on the Internet. The SONAs are stored in a database residing on a cloud server, FIG. 2 001.

STEP 5. A SONAD Sound Code, FIG. 2 007 is merged with (or embedded into) an audio track 008 of a song, video, live broadcast, podcast, etc. Since the SONAD Sound Code is imperceptible to humans, it does not affect the content of the audio track that carries the SONAD Sound Code with it.

STEP 6. The audio track with an embedded SONAD Sound Code, FIG. 2 009 is played over airways or by the arena or public address systems to the users' mobile devices, FIG. 3 003 through audio speakers FIG. 3 001.

STEP 7. The SONAD app FIG. 3 003 installed on a mobile device that is designed to intercept, via device's microphone and interpret the SONAD Sound Codes, FIGS. 2 007 and 009 “listens” to the audio track with the embedded SONAD Sound Code. Once the SONAD Sound Code is intercepted and identified, the SONAD app makes the SONA associated with that specific SONAD Sound Code in the cloud database (FIG. 2 002), along with its multimedia content available to the users on their mobile devices (FIGS. 3 003, 004, 005, and 006).

STEP 8. The SONAD Visual Code Reader which is an integral part of the SONAD app (FIG. 3 003) uses the mobile device's camera to read and interpret the SONA's SONAD Character Codes expressed as strings of characters, FIG. 2 005. Once the SONAD Visual Code is scanned by the users and the string it contains is confirmed as a valid SONA code, the SONAD app delivers the SONA associated with that specific SONA code along with its multimedia content stored in the cloud database (FIG. 2 002) to the users' mobile devices (FIGS. 3 003, 004, 005, and 006).

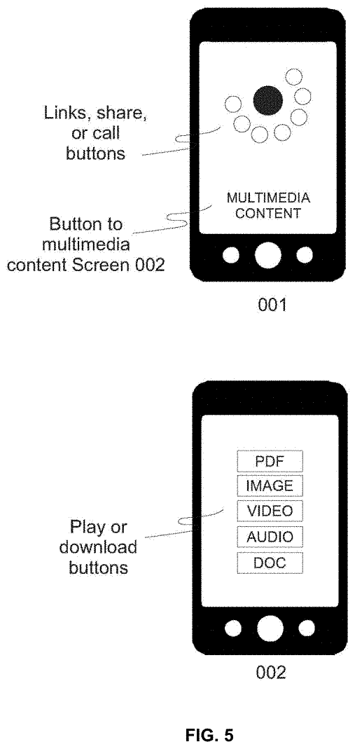

STEP 9. The identified SONA (FIG. 2 001) is displayed by SONAD app on the screen of a mobile device (FIGS. 3 003, 004, 005, and 006) allowing the user to access and use its multimedia content (FIGS. 5 001 and 002): read text, view pictures, listen to audio clips, watch videos, visit Internet sites using the web and social media links, or make quick one-touch-button calls.

STEP 10. The codes for all SONAs (FIG. 2 003) received on the individual users' mobile devices are stored on the users' devices (FIG. 3 003) while its multimedia content is stored in the cloud database (FIG. 2 002) and is available for a consequent use by the users indefinitely.

Referring now to FIG. 4, the flowchart shows the main functional blocks of the method in the present invention implemented in the SONAD app, FIG. 3 003.
1. Preparing multimedia materials, FIG. 4, 001. The multimedia content distributor prepares the materials and files intended for distribution, encapsulates them in a SONA FIG. 2 001, and saves that SONA in the cloud database FIG. 2 002. This is accomplished by using an application running on the web and connected via a graphical user interface with a database also located on the web.
2. Create SONA (FIG. 2 001), a content package. The multimedia content distributor then uses the application running on the web to create a SONA and save it in the cloud database, FIG. 4 002.
3. Create sound and SONAD Visual Codes. The multimedia content distributor then uses the application running on the web to automatically create (a) the SONAD Sound Code FIGS. 2 006 and 007 that can be embedded into any sound track and (b) the customized SONAD Visual Code FIG. 2 004 that can be printed on the pages of any publication or poster or displayed on any electronic screen. When the SONAD Sound Code FIGS. 2 007 and 009 is played (FIG. 3 001) or the SONAD Visual Code is scanned by the mobile app's SONAD Visual Code reader (FIG. 3 003), the SONA (FIG. 2 001) is sent to the mobile phones running the mobile app, FIG. 3 003.
4. Deliver SONA to mobile phone or tablet. The multimedia content distributor then plays the audio track with embedded SONAD Sound Code, FIG. 2 007 and 009 or advises the SONAD app users to scan the SONAD Visual Code, FIG. 2 004. The SONA carrying the multimedia content, FIG. 2 001 is delivered then to the mobile phone or tablet running the app (FIG. 3 003) and is displayed on the screen for review, use, action, and downloading the content, FIGS. 3 004, 005, and 006. The access to the content will stay on the mobile phones indefinitely. The content will get updated automatically when any modifications are made to it by the content providers.
   In the invented method, a mobile app, FIG. 3 003 identifies SONAD Sound Codes, FIGS. 2 007 and 009 embedded into any audio tracks or encoded in SONAD Visual Codes (FIG. 2 004). Once a positive identification is completed, the app downloads the unique multimedia data package (SONA, FIG. 2 002) linked to the identified SONAD Sound Code FIG. 2 006 from an electronic database to the user's mobile device, and then allows the user to display on the mobile device's screen the information and links relevant to the content of the program that was encoded with that specific SONAD Sound Code. Identical sequence of actions takes place when the associated SONAD Visual Code (FIG. 2 004) from the printed media or any electronic, PC or TV screen is scanned and identified by the app.

The SONAD Visual Code Reader is an integral part of the present invention. Visual Code Reader is designed for reading SONAD Visual Code images FIG. 2 006 (the example is provided for illustration purposes only) carrying unique SONA character codes, FIG. 2 005 encoded into Visual Code images. The SONAD Visual Code Reader's code algorithm includes the following software modules:

Module 1: Algorithm for the phone's camera locating and identifying an image of a SONAD Visual Code image when present in its view while focused on a printed page or an electronic display

Module 2: Using an image analysis code, read the SONA's unique character code (FIG. 2 005)

Module 3: Pass the SONA's character code to the app which will trigger sending the specific SONA (FIG. 2 002) to the user's phone (FIG. 3 003)

Other aspects of the invention include a mobile app SONAD running on phones and electronic tablets that is capable of listening and analyzing sounds and scanning special SONAD Visual Codes. The SONAD app is able to identify sounds of prescribed frequency that are embedded into sound tracks of any broadcast, pre-recorded or live. A combination of such sounds of different frequencies (FIG. 1 004) constitute the SONAD Sound Codes, similar to traditional printed barcodes.

A standard Fast Fourier Transform may be used for identification of the SONAD Sound Codes; alternatively, a similar custom-made algorithm can be developed for this purpose. Once a specific SONAD Sound Code is identified, the app is configured to identify the unique, character string FIG. 2 003 associated with the SONAD Sound Code. Each unique string is linked to a unique data package (SONA, FIG. 2 001) contained in a database stored on the database maintained in the Internet cloud. The app may then access or download the identified data package (SONA, FIG. 2 001) from the database to the user's mobile device, making it available for further use.

For some embodiments of the invention to function, the following elements should be provided: (1) a mobile app capable to intercept and identify SONAD Sound Codes embedded in sound tracks of any broadcast or scan and identify special SONAD Visual Codes, (2) mobile electronic device capable of running the app, (3) sound tracks with SONAD Sound Codes embedded in them, (4) database containing data packages with multimedia content that are linked to the SONAD Sound Codes embedded in sound tracks, (5) a system correlating each element of the SONAD Sound Code character string to a specific unique sound frequency in the sound spectrum maintained in the custom CHARACTER-FREQUENCY TABLE (FIG. 1 003).

The set of specific sound frequencies used in the method can be chosen by the app and SONAD Sound Code developers. Also, the database containing data packages (SONAs) can be installed on any server available to the developer. Developers can create multiple databases stored locally or in the internet cloud and serving different groups of customers, with each group using its own set of SONAD Sound Codes.

The following non-limiting examples are illustrative for use of the invention. An individual user (consumer) equipped with a mobile phone or electronic tablet will be able to receive content-related information from any broadcast or advertisement without interrupting the flow of the broadcast. All this information, including textual, video, graphics, and sound, is made available to the user seamlessly, in real time and contextualized with any program—radio, TV, public address system, live or pre-recorded, or delivered via Internet. The present invention makes advertising less disruptive to consumers and thus enhances their enjoyment of the broadcasts, programs, and other materials transmitted with the use of audio track.

Use of the Sona SONAD Visual Code scanning capability expands the present invention by allowing it to be applied effectively for delivering multimedia content via printed and electronic display-based media channels, thus making it a universal platform working for any information-delivering channel. Specifically, all the information delivered through audio track, as listed above can also be obtained by the users on their mobile phones through scanning SONAD Visual Codes printed on paper or displayed on any electronic screen, including TV, PC or laptop computer.

For a commercial user (broadcaster, producer, advertiser), the present invention allows the commercial user to discover the audience's preferences in their programs or advertisements, the delivery formats and content, and attribution. These data allow the producers to adjust their programs in response to the quantifiable preferences of the listeners and viewers, making their business more enjoyable to the consumers and more cost-effective for the commercial user.

The present invention can be used for content and information distribution and exchange at conferences and trade shows and in lecture halls and classrooms, providing a non-interrupting flow of contextualized information inaudibly, in real time. As an example, the present invention implemented in SONAD app was used at a university campus in a lecture hall environment for delivering to the students' phones the content relevant to the lecture. At the same university, it was also tested for delivering SONAs providing information about different departments during tours to the newly admitted students at the Open House events.

The present invention can also be used in medical offices, public transportation and cars. The SONAD Visual Code scan delivery function of an app based on the present invention can be used with specially designed Smart Product Labels containing SONAs delivering to the customer phones various multimedia content about the products, such as working and maintenance instructions, drawings and illustrations, video guides and examples of use. At trade shows and conferences, the apps based on the present invention can provide an easy method for exchanging individual's or company's point of contact (POC) actionable information during face interactions, effectively replacing the traditional business cards.

The present invention can also be used to deliver action guides on the mobile phones via public address systems during emergency situations for customers in malls, stores, shopping plazas and for guests at convention centers or sporting events.

The system of the present invention may include at least one computer with a user interface. The computer may include any computer including, but not limited to, a smart device, such as tablet and smart phone, a desktop, and laptop. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be understood, of course, that the foregoing relates to exemplary embodiments of the invention and that modifications may be made without departing from the spirit and scope of the present invention. The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A sound code comprising,
(a) a series of human inaudible sound elements which encode at least one alphanumeric string of data,
wherein the sound code is receivable by a microphone in wireless or wired connection with a mobile computing device,
wherein the mobile computing device has application software that identifies the sound code,
wherein the application software interprets the sound code to determine the at least one alphanumeric string of data
wherein the application software queries a database with the at least one alphanumeric string of data and
wherein the database returns one or more multimedia content or links to multimedia content to the mobile computing device in response to the query.

2. The sound code of claim 1 wherein the one or more multimedia content or links to multimedia content are associated with the at least one alphanumeric string of data.

3. The sound code of claim 1 wherein the one or more multimedia content or links to multimedia content are saved as a single file in a cloud computing environment.

4. The sound code of claim 1 wherein the one or more multimedia content or links to multimedia content are stored in a database in a cloud computing environment.

5. The sound code of claim 1 wherein the one or more multimedia content or links to multimedia content are formatted into a content package by a web-based application.

6. A method of providing multimedia content to a mobile computer device comprising the steps of:
(i) associating at least one alphanumeric string of data with one or more multimedia content or links to multimedia content stored in a networked computing system,
(ii) encoding the at least one alphanumeric string of data into at least one human inaudible sound signal,
(iii) broadcasting the at least one human inaudible sound signal,
(iv) receiving on a mobile computing device via a microphone the at least one human inaudible sound signal,
(v) decoding the at least one human inaudible sound signal via application software on the mobile computing device to form the at least one alphanumeric string of data,
(vi) transmitting the at least one alphanumeric string of data to the networked computing system,
(vii) receiving at the networked computing system the at least one alphanumeric string of data,
(viii) transmitting to the mobile computing device the one or more multimedia content or links to multimedia content.

7. The method of claim 6 wherein the one or more multimedia content or links to multimedia content are associated with the at least one alphanumeric string of data.

8. The method of claim 6 wherein the one or more multimedia content or links to multimedia content are saved as a single file in a cloud computing environment.

9. The method of claim 6 wherein the one or more multimedia content or links to multimedia content are stored in a database in a cloud computing environment.

10. The method of claim 6 wherein the one or more multimedia content or links to multimedia content are formatted into a content package by a web-based application.

11. A visual code comprising,
(a) a visual element which encodes at least one alphanumeric string of data,
wherein the visual element is receivable by a camera in wireless or wired connection with a mobile computing device,
wherein the mobile computing device has application software that identifies the visual element,
wherein the application software interprets the visual element to determine the at least one alphanumeric string of data
wherein the application software queries a database with the at least one alphanumeric string of data and
wherein the database returns one or more multimedia content or links to multimedia content to the mobile computing device in response to the query.

12. The visual code of claim 11 wherein the one or more multimedia content or links to multimedia content are associated with the at least one alphanumeric string of data.

13. The visual code of claim 11 wherein the one or more multimedia content or links to multimedia content are saved as a single file in a cloud computing environment.

14. The visual code of claim 11 wherein the one or more multimedia content or links to multimedia content are stored in a database in a cloud computing environment.

15. The visual code of claim 11 wherein the one or more multimedia content or links to multimedia content are formatted into a content package by a web-based application.

16. A method of providing multimedia content to a mobile computer device comprising the steps of:
(i) associating at least one alphanumeric string of data with one or more multimedia content or links to multimedia content stored in a networked computing system,
(ii) encoding the at least one alphanumeric string of data into at least one visual element,
(iii) placing the at least one visual element within view of a camera in wireless or wired connection with a mobile computing device,
(iv) receiving on a mobile computing device via the camera the at at least one visual element,
(v) decoding the at least one visual element via application software on the mobile computing device to form the at least one alphanumeric string of data,
(vi) transmitting the at least one alphanumeric string of data to the networked computing system,
(vii) receiving at the networked computing system the at least one alphanumeric string of data,
(viii) transmitting to the mobile computing device the one or more multimedia content or links to multimedia content.

17. The method of claim 16 wherein the one or more multimedia content or links to multimedia content are associated with the at least one alphanumeric string of data.

18. The method of claim 16 wherein the one or more multimedia content or links to multimedia content are saved as a single file in a cloud computing environment.

19. The method of claim 16 wherein the one or more multimedia content or links to multimedia content are stored in a database in a cloud computing environment.

20. The method of claim 16 wherein the one or more multimedia content or links to multimedia content are formatted into a content package by a web-based application.
